(19) United States
(12) Patent Application Publication
(10) Pub. No.: US 2015/0173556 A1
(43) Pub. Date: Jun. 25, 2015

(54) Strainer

(71) Applicant: Free-Gen Innovations Pty Ltd, Clovelly, New South Wales (AU)

(72) Inventors: Tom Freeman, Clovelly (AU); Moana Nguyen, Greenfield Park (AU)

(21) Appl. No.: 14/408,198

(22) PCT Filed: Jun. 14, 2013
(86) PCT No.: PCT/AU2013/000638

§ 371 Date: Dec. 15, 2014

(30) Foreign Application Priority Data
Jun. 15, 2012 (AU) 2012902518

(51) Int. Cl. A47J 31/06

(52) U.S. Cl. CPC A47J 31/06

(57) ABSTRACT

A strainer that includes a base having a plurality of openings to permit liquid to pass therethrough. A wall extends away from the base to define an opening having a lip. The strainer may be configured operatively associated with a container to receive the liquid. The container has a bottom and an upwardly extending wall. The lip is configured to engage the wall of the container so that the base of the strainer in use is positionable away from the bottom of the container to divide the container into first and second spaces. The second space may be configured to receive a product to be brewed.

### FIELD

The present invention relates to a strainer and in particular to a strainer for a beverage such as tea or the like.

### BACKGROUND

Beverages such as tea, coffee or the like are commonly drunk throughout the world. Tea and coffee typically come in raw and ground forms packaged individually or within a coffee, tea bag or the like. When drinking loose leaf tea, for example, a strainer is typically held over the top of a container such as a cup and a liquid such as hot water or the like is poured through the strainer holding the loose leaf tea to infuse or brew the tea in the water. The strainer also allows the tea to flow into the cup without the tea leaves. In tea pots or the like loose leaf tea is typically placed in the pot and the resulting infused tea poured into a cup. In some cases, an infuser is located within the teapot to hold the tea leaves. Though these methods of brewing tea are generally effective, they are too slow and too wasteful when considering a take away cup of tea at a café, restaurant or the like. For example, a whole tea pot might need to be brewed for only a single user. They also typically leave tea leaves in the cup.

If a standard strainer is utilised, the strainer or infuser sits on top of the cup and once the water level reaches two-thirds or lower, water is no longer in contact with the tea limiting the diffusion of tea in the water. With such devices a take away lid or the like cannot be added to a cup and when using a standard infuser or strainer a consumer would need to wait until the tea has been brewed before moving on to the next customer which would delay the consumer and the café owner. Similarly, a tea bag must be left in the cup of tea and particular tea bags need to be selected for the different types of tea. The tea bag is also not secured to the top of the container and therefore within a standard take away cup is likely to block the drinking spout of a lid. A tea bag is also messy to utilise and only the popular types of tea are manufactured within tea bags. That is, the consumer is limited to choice of tea and needs to dispose of the tea bag themselves. The current methods of providing a cup of tea and in particular take away tea is very slow. Time and speed is paramount in a busy café environment.

Accordingly, there is a need for a take away tea cup permitting a user to choose any type of loose leaf tea and a tea cup that provides sufficient brewing of that tea. There is also a need for a take away cup of tea that can be handed to a consumer in seconds and brewing can continue without the customer and server waiting.

### OBJECT

It is an object of the present invention to substantially overcome or at least ameliorate one or more of the disadvantages of the prior art, or to at least provide a useful alternative.

### SUMMARY

There is disclosed herein a strainer including:

a base having a plurality of openings to permit liquid to pass therethrough, and a wall extending away from said base to define an opening having a lip;

said strainer in use operatively associated with a container to receive said liquid, said container having a bottom and an upwardly extending wall, said lip adapted to engage said wall of said container so that said base of said strainer in use is positionable away from said bottom of said container to divide said container into first and second spaces, said second space in use adapted to receive a product to be brewed.

Preferably, said lip is sealingly engageable with said container wall in use.

Preferably, said base includes one or more protuberances extending away from said base and adapted in use to locate said base of said strainer at a spaced apart location from said bottom of said container.

Preferably, said base and walls of said strainer are radial.

Preferably, said base of said strainer includes a raised portion.

Preferably, said openings are located on said raised portion.

Preferably, said wall of said strainer includes a circumferential shelf

Preferably, said strainer is made of a disposable and/or recyclable material.

Preferably, said openings are perforations.

Preferably, said openings are slits extending radially away from a centre of said strainer.

Preferably, said slits include an opening and a cover partially covering said opening.

Preferably, said lip includes a plurality of spaced apart notches.

Preferably, said wall includes a plurality of spaced apart ribs forming slots on an underside of said strainer.

Preferably, said base includes one or more protuberance extending away from said base, at least one said opening extending through said protuberance.

Preferably, said base includes a plurality of protuberances and corresponding openings extending therethrough.

### BRIEF DESCRIPTION OF DRAWINGS

FIG. 1 is a top view of an embodiment of the present invention:

FIG. 2 is a bottom view of FIG. 1;

FIGS. 3 and 4 are front and side views of FIG. 1;

FIG. 5 is an isometric top view of FIG. 1;

FIG. 6 is an isometric bottom view of FIG. 1;

FIG. 7 is an in use isometric view of FIG. 1;

FIG. 8 is a top perspective view of a further embodiment of the present invention;

FIG. 9 is a top view of FIG. 8;

FIG. 10 is a side view of FIG. 9;

FIG. 11 is a bottom view of FIG. 9;

FIG. 12 is a bottom perspective view of FIG. 8;

FIG. 13 is a top perspective view of FIG. 12;

FIG. 14 is a cross sectional view along B-B of FIG. 9;

FIG. 15 is a further embodiment of the present invention;

FIGS. 16a to 16f is a further embodiment of the present invention;

FIGS. 17a to 17f is a further embodiment of the present invention; and

FIGS. 18a to 18f is a further embodiment of the invention.

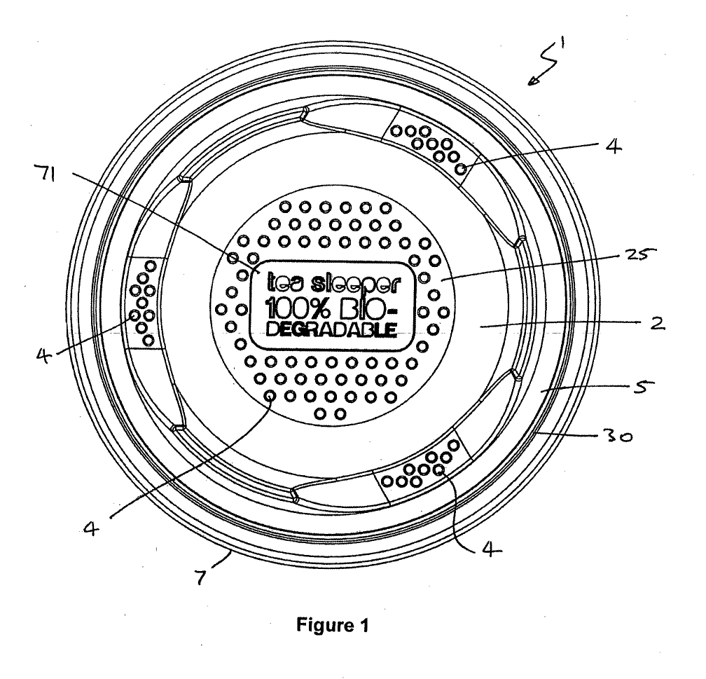

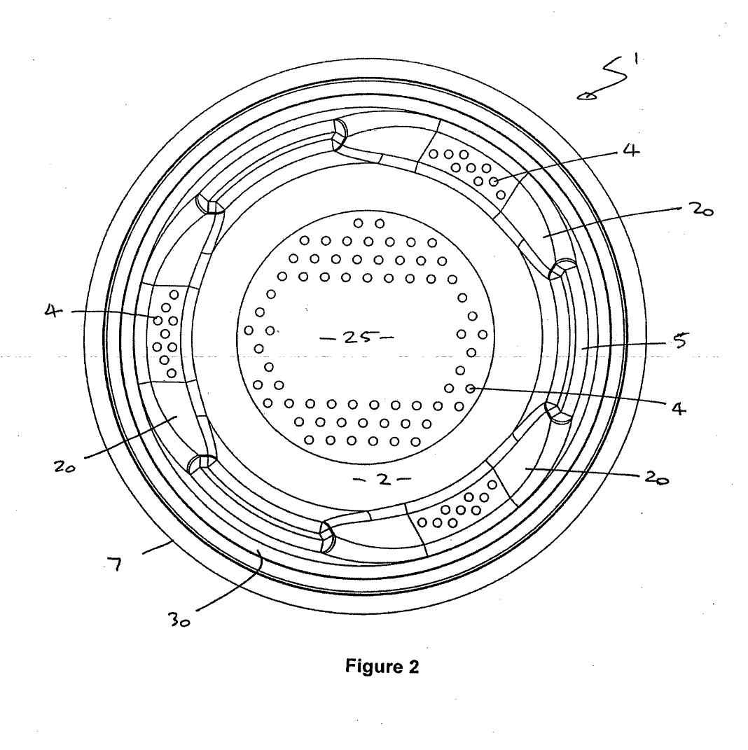

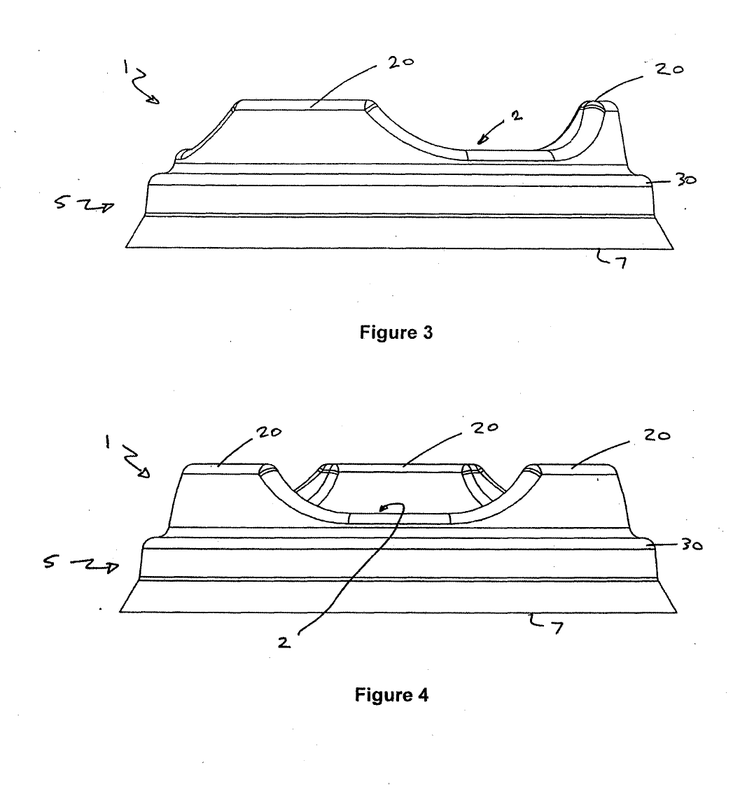

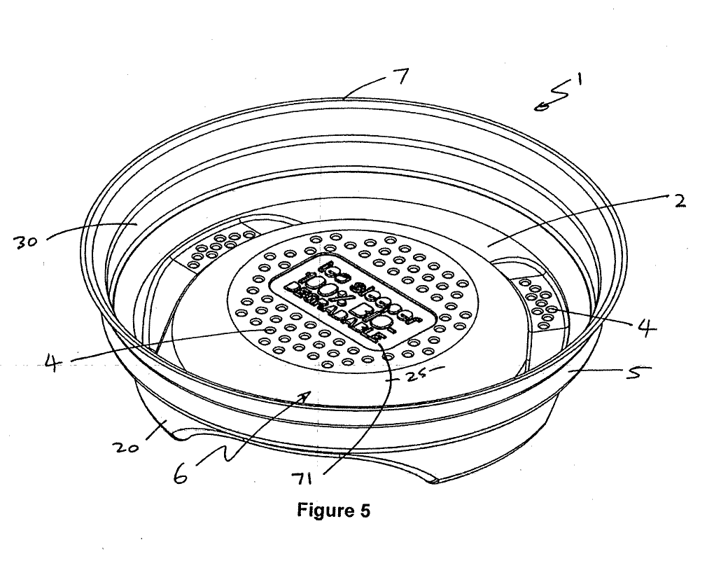

### DESCRIPTION OF EMBODIMENTS

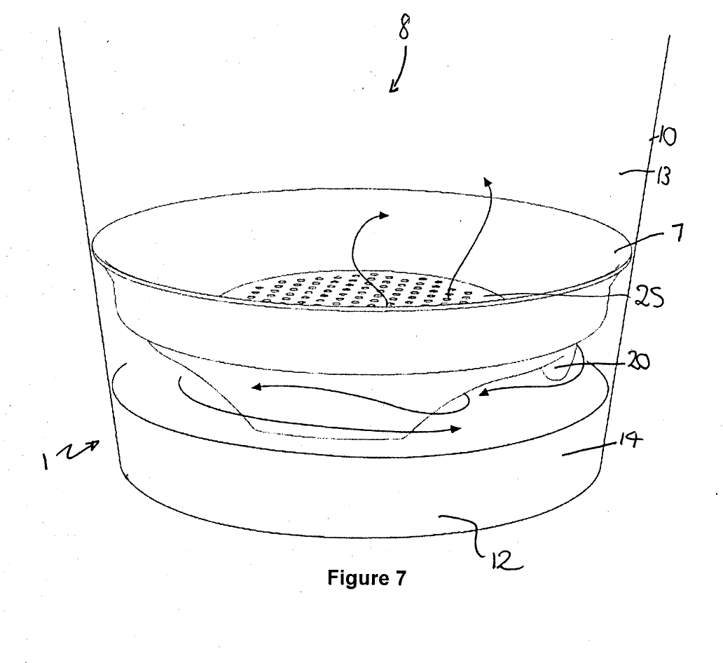

There is disclosed herein a strainer 1 including a base 2 having a plurality of openings 4 located therein to allow liquid such as water to pass therethrough. The liquid may be hot or cold. The openings 4 can be in the form of holes, slits, slots perforations or the like. A wall 5 extends away from the base 2 to define an opening 6 having a lip 7. A logo 71 or the like can be positioned on the base 2. The strainer 1 in use is operatively associated with a container 8 to receive a liquid. The lip 7 is adapted to engage a wall 10 of the container 8 so that the strainer 1 in use is positionable above a bottom 12 of the container 8 in use as best seen in FIG. 7. The base 2 of the strainer 1 in an embodiment includes one or more protuberances 20 (or legs) extending away from the base 2 and adapted to assist with locating the base 2 of the strainer 1 at a location spaced away from the bottom 12 of the container 8. The strainer 1 is adapted in use to divide the container 1 into first and second spaces 13, 14. Tea, coffee or the like is positionable in the second space 14 so that it is between the strainer 1 and bottom 12 in use. In the preferred form, the container 8 is a standard take away coffee or tea cup with the base 2 and wall 5 of the strainer 1 being radial or circular to fit within such a coffee/tea take away cup 8. However, any container 8 could be utilized and the strainer 1 manufactured to fit. For example, the strainer 1 could be made to fit various shaped tea pots. The strainer 1 could be removable after use or fixed in place and does not need to contact the bottom 12 of the container 8. The base 2 further includes one or more raised portions 25 adapted to assist with the brewing of the tea or the like within the container 8. Similarly, the wall 5 can include one or more shelves, steps 30 or the like to assist with brewing of the tea, allow the strainer 1 to be stacked for transport and to assist sealing of the lip 7 with the wall 10 of the container 8. The lip 7 could be flexible or rigid or manufactured from the same or a different material to that of the base 2.

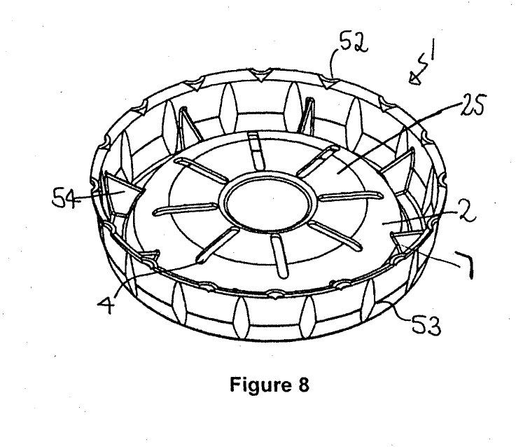

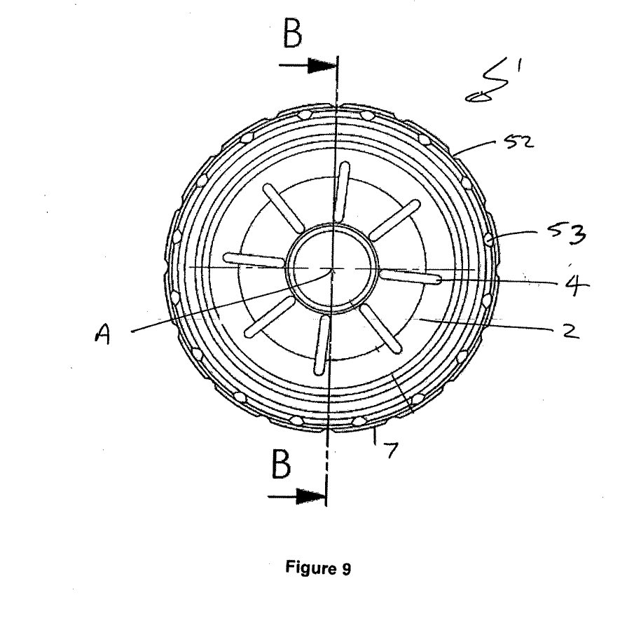

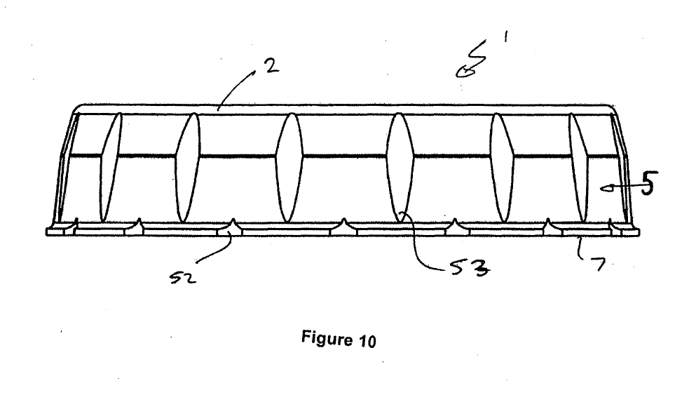

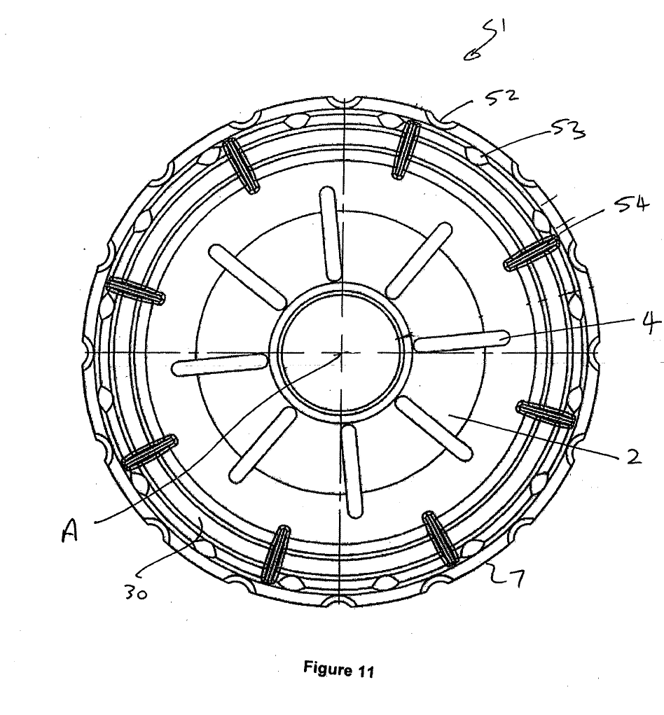

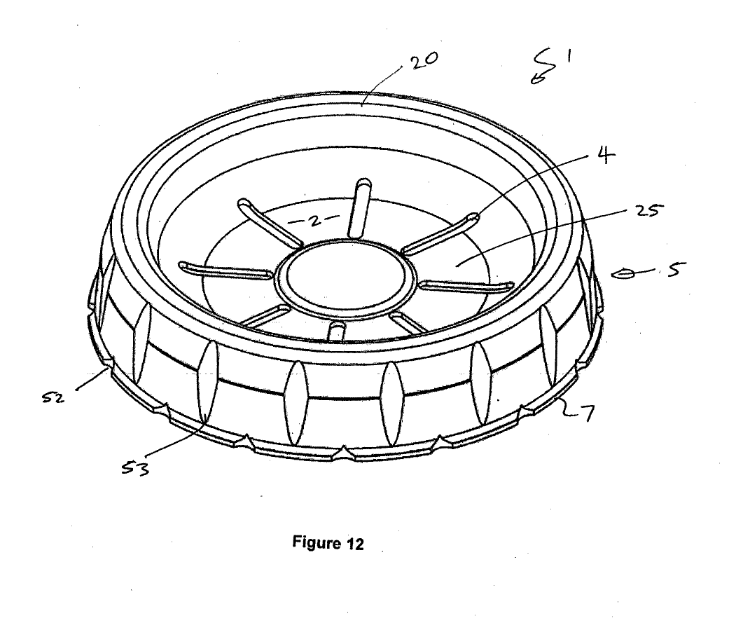

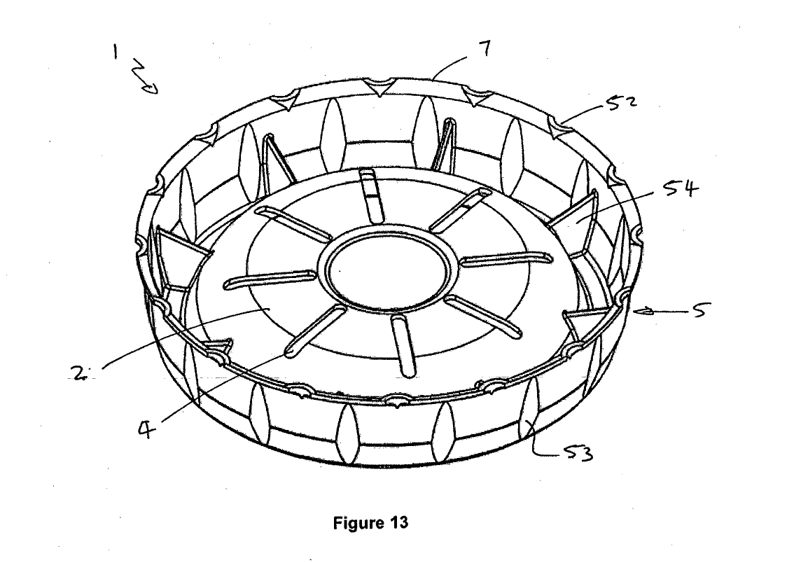

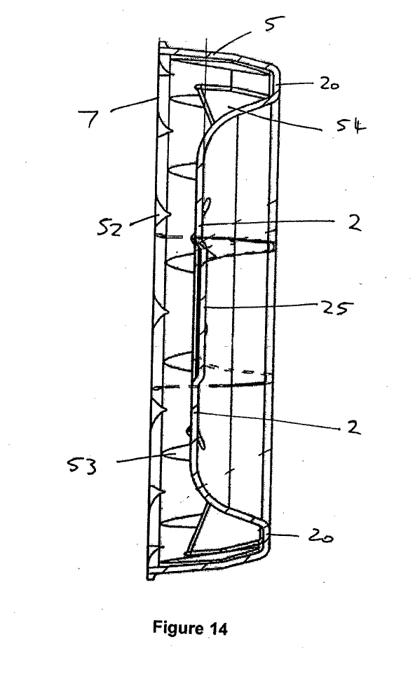

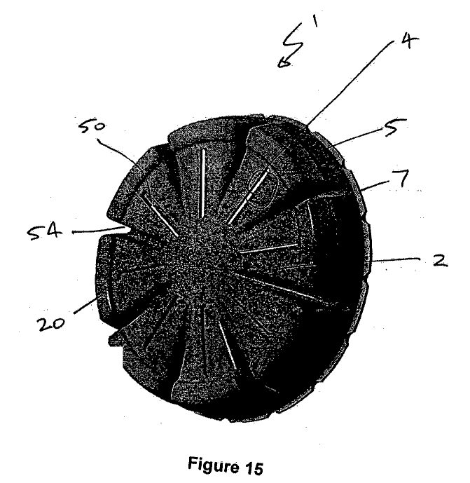

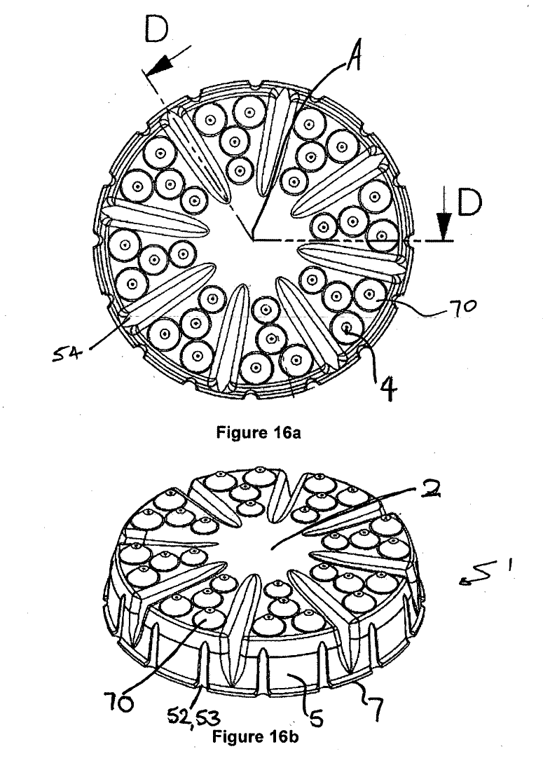

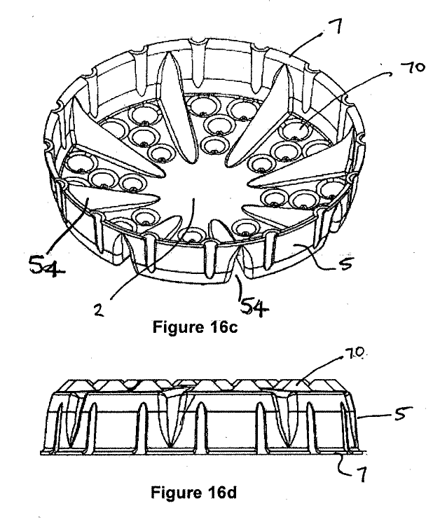

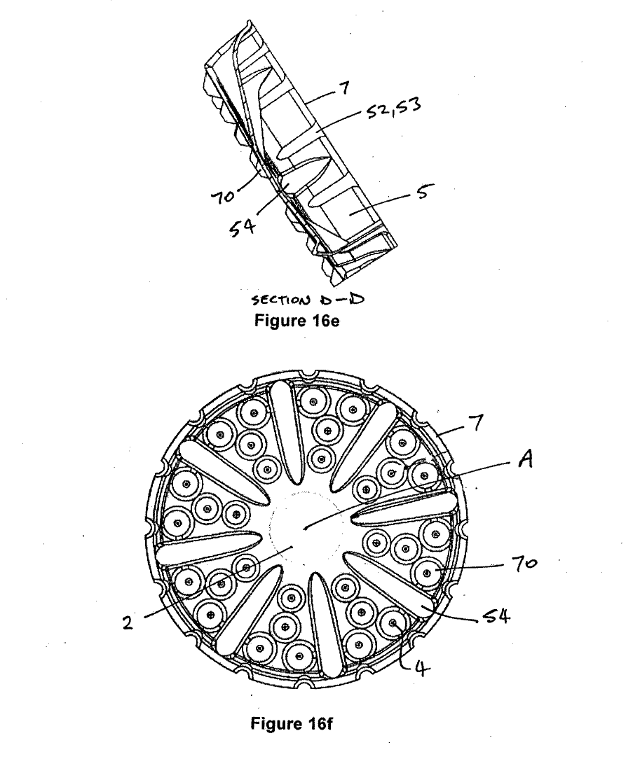

In FIGS. 9 to 15, a further embodiment of the invention is shown. In this embodiment, the openings 4 take the form of a plurality of slots extending radially away from a centre A of the strainer 1. As shown in FIG. 16, the slots 4 can include a cover 50 which partially disrupts the flow of liquid through the openings 4. This arrangement has been found to assist with removal of air initially located below the strainer 1 in the second space 14 whilst preventing tea leaves or the like from moving past the strainer 1 into the first space 13. In this regard, the lip 7 and wall 5 can also include a plurality of cuts, slits, notches or channels 52, 53 to also assist with liquid and air movement about the strainer 1 and to enhance the brewing process. The strainer 1 may also include a plurality of ribs 54 to add structural integrity to the strainer 1. In FIG. 8 you will see that notches 53 are in a diamond shape. In FIG. 15 you will see the channels 54 are in a triangular shape.

In FIGS. 16a to 16f a further embodiment of the invention is shown. In particular, the openings 4 are located on the ends of protrusions 70 in this particular form the protrusions 70 are in the form of a cone having a spaced apart base leading upwardly to an apex so that one end of the protrusions 70 is small and one large which advantageously provides better flow dynamics for liquid to pass through the strainer 1 while inhibiting tea leaves or the like from moving from the second space 14 to the first space 13. As can be seen in the figures, the protrusions 70 are generally equally spaced about the base 2 with respect to the centre A. However, they could be in any random or non-random order and be of any shape. The wall 5 and lip 7 include notches 52, 53 being formed together (rather than being separate as in for example FIG. 12). The embodiment shown in FIGS. 16a to 16f also includes channels and ribbings 54. Again, these channels and ribbings 54 can be equally spaced about a circumference of the strainer 1 or could be randomly or non-randomly positioned and could be of various shapes to help with fluid and air dynamics.

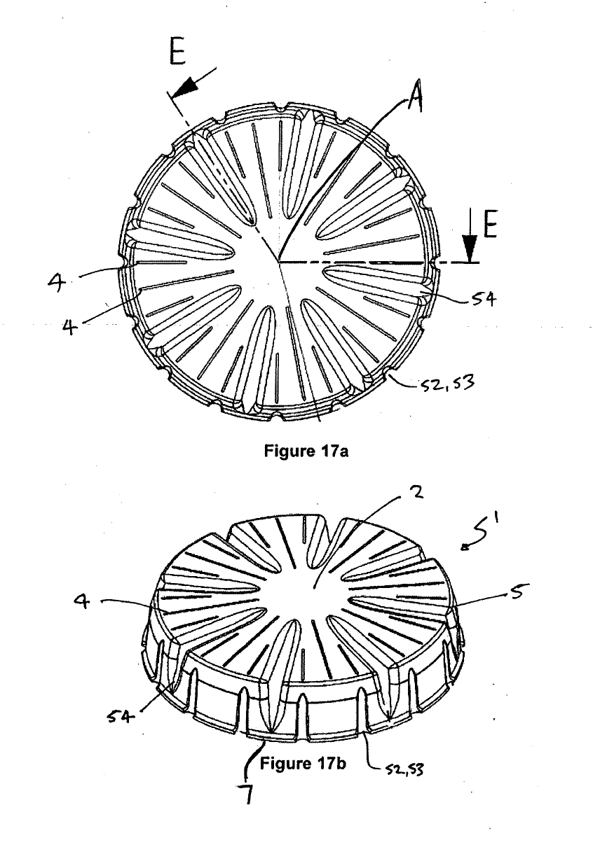

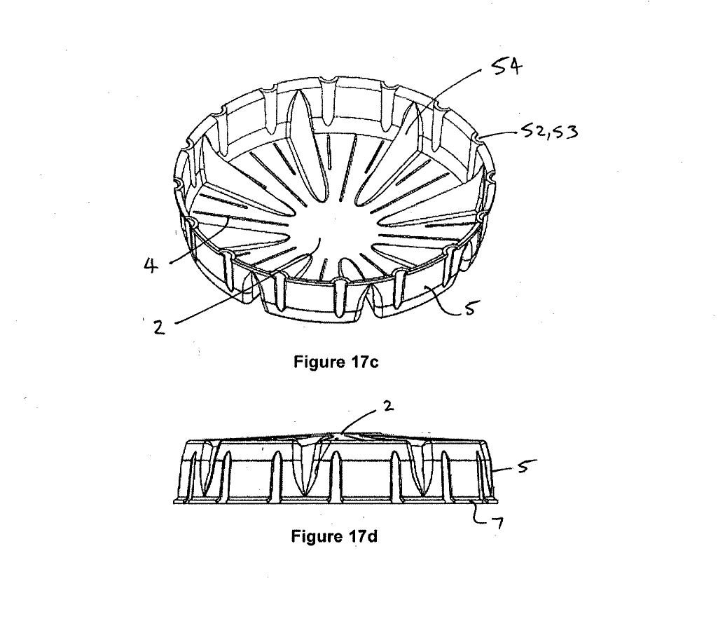

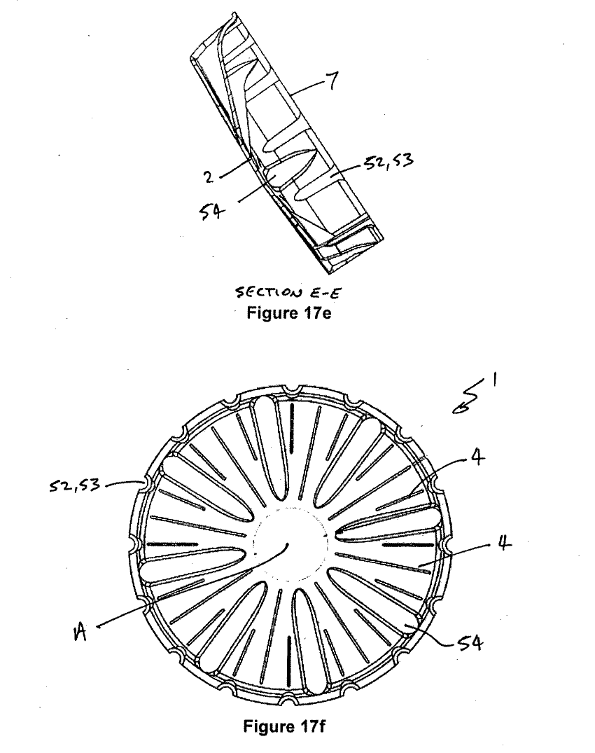

In the embodiment shown in FIGS. 17a to 17f, the openings 4 are in the form of elongate slits. It will be noted that the slits 4 while extending radially from the centre A are of various lengths. They could also be broken along the same line so that they form a “dashed” pattern. The openings 4 in the form of the slits as shown can be spaced either uniformly or non-uniformly about the base 2. The strainer shown also includes notches 52, 53 being a single feature and there is also shown the channels and ribs 54.

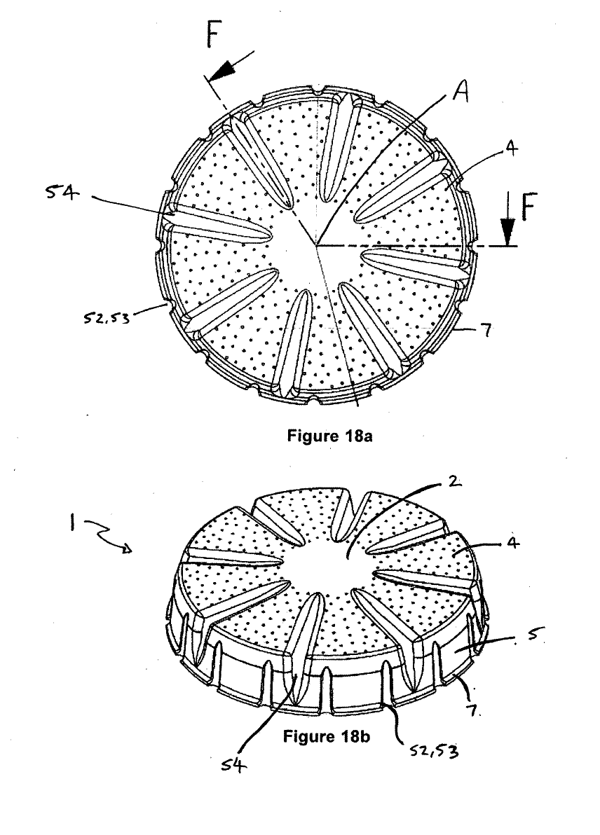

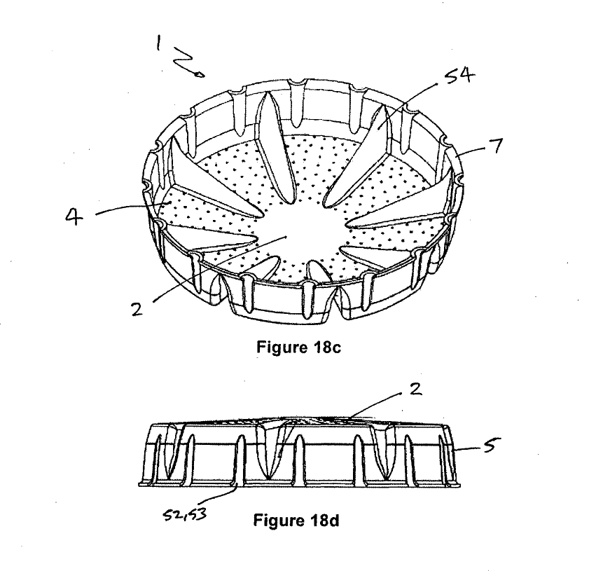

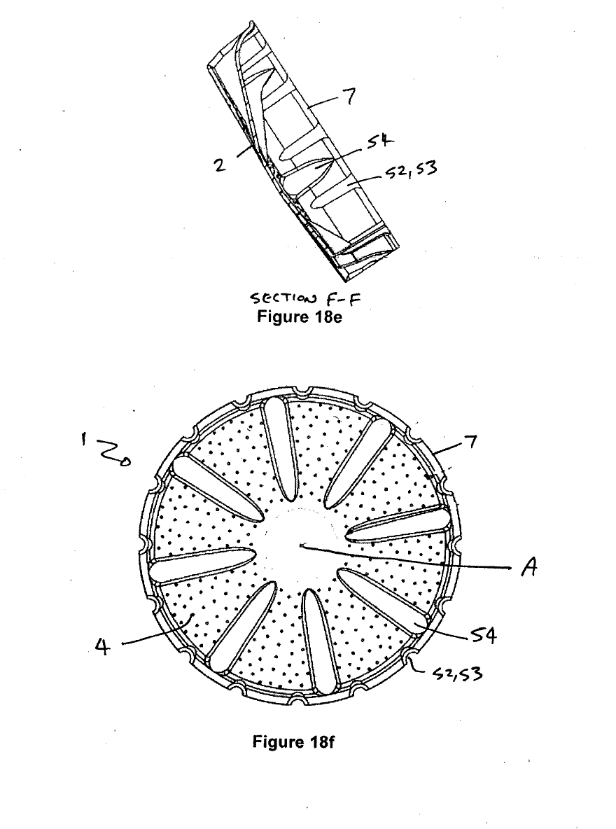

In the embodiment shown in FIGS. 18a to 18f, the openings 4 are in the form of a plurality of pin holes or the like. These holes 4 while generally shown being radially extending from the centre A can be in uniform or non-uniform order across the base 2. The wall 5 and rim 7 include notches 52, 53 as a single feature as shown and there are also included channels and ridges 54 to add stability to the strainer 1 and assist with air and liquid flow dynamics.

In use, the strainer 1 would be utilized by cafes, restaurants or the like to provide customers with a take away cup of tea, coffee or the like. The method of brewing such would include a customer choosing their particular coffee beans, tea leaves or the like which are then positioned into the take away cup 8 at the bottom 12. The strainer 1 is then inserted into the cup 8 and positioned towards the bottom 12 of the cup 8 over the top of the beans, leaves or the like located in the second space 14. A liquid such as water or the like is then added to the cup 8 with the water flowing through the openings 4 of the strainer 1 into the first and second spaces 13, 14. A lid (not shown) of the cup 8 is placed in position as is typical with a take away cup of coffee. The customer now has a take away tea or coffee that has been prepared in a matter of seconds. The particular shape of the strainer 1 allows for continual brewing of the coffee or tea located between the strainer 1 and the bottom 12 of the container 8 while the customer is not in the café. Accordingly, the customer is moved through the café quickly and the server has not been delayed from serving other customers.

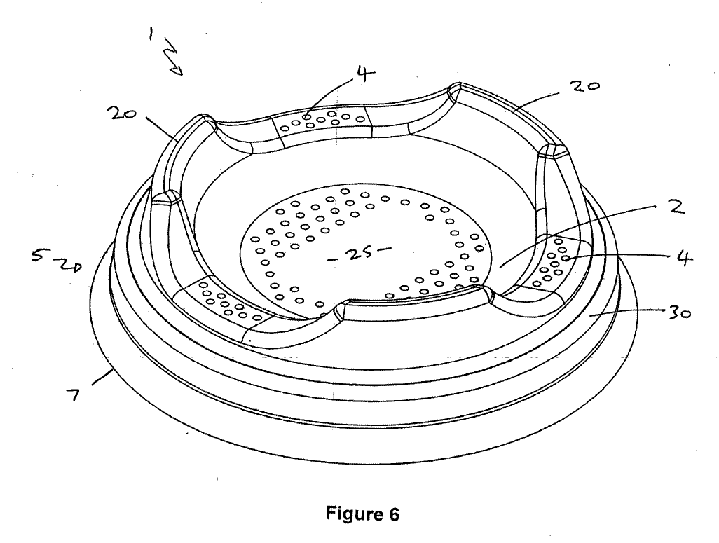

In the preferred embodiment, the strainer 1 allows for efficient nesting with other strainers 1. This allows improved packaging and shipping. The openings 4 allow for the tea or the like to infuse and flow back into and around the cup 8. The openings 4 are typically limited to the flat surfaces of the base 2 to assist in production. However it should be noted that openings 4 could also be included on other surfaces such as the wall 5, legs 20, lip 7, or the like, see for example FIG. 6. The openings 4 could also extend from the base 2 up the wall 5 as shown in FIG. 12. The strainer 1 can contact the bottom 12 of a typical coffee cup 8 in three points as shown in FIG. 7 by way of the protuberances or legs 20. There could however be one leg, many legs 20 or no legs. The leg 20 in for example FIG. 12 extends about the entire circumference of the strainer 1. The legs 20 leave gaps 40 for tea, water or air to circulate throughout and around the cup 8 to prevent any dead spots from occurring during the brewing process. It should be noted in FIG. 7 that the legs 20 are spaced away from the wall 10 of the container 8. They could however be flush with the wall 10. The lip 7 could also be sufficiently designed to prevent the use of legs as shown in FIGS. 9 to 15. The strainer 1 could be made of any material, however in the preferred form would be made of a biodegradable or recyclable material. The strainer 1 could also be made of the same material as the container 8. It should include a good surface finish and be cheap and easy to manufacture. The openings 4 size should be sufficiently small to prevent typical tea leaves or the like from moving beyond the strainer 1 into the general reservoir of the cup 8 (space 13), whilst permitting air to escape.

Although the invention has been described with reference to specific examples, it should be understood that the present invention can be embodied in many other forms.

1. A strainer including:
a base having a plurality of openings to permit liquid to pass therethrough, and
a wall extending away from said base to define an opening having a lip,
said strainer in use operatively associated with a container to receive said liquid, said container having a bottom and an upwardly extending wall, said lip configured to engage said wall of said container so that said base of said strainer in use is positionable away from said bottom of said container to divide said container into first and second spaces, said second space in use configured to receive a product to be brewed.

2. A strainer according to claim 1, wherein said lip is sealingly engageable with said container wall in use.

3. A strainer according to claim 1, wherein said base includes one or more protuberances extending away from said base and configured in use to locate said base of said strainer at a spaced apart location from said bottom of said container.

4. A strainer according to claim 1, wherein said base and walls of said strainer are radial.

5. A strainer according to claim 1, wherein said base of said strainer includes a raised portion.

6. A strainer according to claim 5, wherein said openings are located on said raised portion.

7. A strainer according to claim 1, wherein said wall of said strainer includes a circumferential shelf.

8. A strainer according to claim 1, wherein said strainer is made of a disposable and/or recyclable material.

9. A strainer according to claim 1, wherein said openings are perforations.

10. A strainer according to claim 4, wherein said openings are slits extending radially away from a center of said strainer.

11. A strainer according to claim 10, wherein said slits include an opening and a cover partially covering said opening.

12. A strainer according to claim 1, wherein said lip includes a plurality of spaced apart notches.

13. A strainer according to claim 1, wherein said wall includes a plurality of spaced apart ribs forming slots on an underside of said strainer.

14. The strainer according to claim 1, wherein said base includes one or more protuberances extending away from said base, at least one said opening extending through said protuberance.

15. A strainer according to claim 14, wherein said base includes a plurality of protuberances and corresponding openings extending therethrough.
